(19) United States
(12) Patent Application Publication
(10) Pub. No.: US 2026/0161626 A1
(43) Pub. Date: Jun. 11, 2026

(54) DATA READ-WRITE METHOD FOR KEY-VALUE DATABASE

(71) Applicant: INNOGRIT TECHNOLOGIES CO., LTD, Pudong (CN)

(72) Inventor: Song DU, Pudong (CN)

(73) Assignee: INNOGRIT TECHNOLOGIES CO., LTD, Pudong (CN)

(21) Appl. No.: 19/415,094

(22) Filed: Dec. 10, 2025

(30) Foreign Application Priority Data
Dec. 11, 2024 (CN) 2024118202181

(51) Int. Cl. G06F 16/22

(52) U.S. Cl. CPC G06F 16/2246

(57) ABSTRACT

Related to the field of databases, and a data read-write method for a key-value database is provided. The embodiments introduce concrete nodes and virtual nodes into a binary hash tree. For a parent node, if either of its child nodes is a virtual node, the parent node is a virtual node, and its value is equal to the value of its non-null-value child node; the hash values of parent nodes that are virtual nodes are neither calculated nor stored. The embodiments also adopt a three-level memory architecture to store different level nodes of the binary hash tree and designs multiple hardware acceleration structures.

### CROSS-REFERENCE TO PRIOR APPLICATIONS

Priority is claimed to Chinese Patent Application No. CN 202411820218.1, filed on Dec. 11, 2024, the entire disclosure of which is hereby incorporated by reference herein.

### FIELD

The present application relates to the field of databases, and in particular, to read-write technologies for key-value databases.

### BACKGROUND

This section is intended to provide background or context for understanding the embodiments of the present application, and is provided for reference only. It should not be construed as an admission by the applicant that this section constitutes prior art publicly disclosed before the filing date of this application.

As the scale of data continues to expand, key-value databases have been widely used in large-scale distributed systems due to their simple and efficient data models and excellent performance. A key-value database is a non-relational database (NoSQL) in which data is stored and accessed in the form of key-value pairs.

In key-value database systems, data integrity verification is an important issue. Traditional data integrity verification methods typically use hash technology, which involves performing a hash operation on the data content to generate a fixed-length hash value. By comparing the hash values of data, it is possible to detect whether the data has been tampered with. However, when a large amount of data needs to be verified, calculating and storing the hash value for each piece of data individually introduces significant storage overhead and computational burden.

To optimize the efficiency of data integrity verification, data structures such as binary hash trees or Merkle trees are commonly used in the industry. A binary hash tree is a tree-like data structure in which the leaf nodes store the hash values of data blocks, and the non-leaf nodes store the combined hash values of their child nodes. This hierarchical structure enables the system to quickly verify the integrity of a large amount of data.

### SUMMARY

In one aspect, the present application provides a data write method for a key-value database. The method comprises the following steps: a processor receiving a write request, the write request comprising key-value pair data; the processor writing the key-value pair data as a data payload to a first memory; the processor calculating a hash value of the data payload and writing the hash value to a binary hash tree stored in a fourth memory as a highest leaf node with a current largest serial number; wherein in the binary hash tree, serial numbers of respective leaf nodes increase in sequence, leaf nodes with serial numbers not greater than that of the highest leaf node are concrete nodes with values being hash values of corresponding data payloads, and leaf nodes with serial numbers greater than that of the highest leaf node are virtual nodes with values being a preset value; the processor determining, in a direction from leaf nodes to a root node, whether respective parent nodes corresponding to the highest leaf node are located within a complete concrete subtree, wherein the complete concrete subtree is a subtree that does not contain any virtual nodes; in response to determining that the parent node is located within the complete concrete subtree, treating the parent node as a concrete node, calculating a hash value of the parent node based on hash values of two child nodes of the parent node, and storing the hash value of the parent node into the fourth memory; and in response to determining that the parent node is not located within the complete concrete subtree, treating the parent node as a virtual node, and when needing to obtain a hash value of the parent node, directly using a value of its child node whose value is not the preset value as the hash value of the parent node.

In another aspect, the present application further provides a data read method for a key-value database. Key-value pair data is stored as data payloads with increasing serial numbers in a first memory, and a binary hash tree is stored in a fourth memory; wherein in the binary hash tree, each leaf position corresponds to a serial number, leaf nodes with serial numbers not greater than a maximum serial number of the data payloads in the first memory are concrete nodes with values being hash values of corresponding data payloads, and leaf nodes with larger serial numbers are virtual nodes with values being a preset value; for a parent node, if either of its child nodes is a virtual node, the parent node is a virtual node, and its value is equal to the value of its child node whose value is not the preset value, otherwise, the parent node is a concrete node, and its value is a result of a hash operation on its two child nodes; the method comprises: a processor receiving a read request from a requesting party device, and reading a requested data payload from the first memory, wherein a leaf node corresponding to the data payload is a target leaf node; the processor generating a proof set for the target leaf node, wherein elements in the proof set are hash values of paired nodes at each level on a path from the target leaf node to a proof target node in the binary hash tree; the proof target node is a root node of a smallest complete concrete subtree containing the target leaf node; the complete concrete subtree is a subtree that does not contain any virtual nodes; the processor returning the requested data payload and the proof set to the requesting party device.

The present application also discloses a non-transitory computer-readable storage medium, wherein the non-transitory computer-readable storage medium stores computer-executable instructions, and the computer-executable instructions, when executed by a processor, implement the steps in the methods described above.

The present application also discloses a computer program product, comprising computer-executable instructions, wherein the computer-executable instructions, when executed by a processor, implement the steps in the methods described above.

### BRIEF DESCRIPTION OF THE DRAWINGS

FIG. 1 is an example of an improved hash tree according to one embodiment of the present application;

FIG. 2 is an example of adding node H13 to a hash tree already containing 12 elements, according to one embodiment of the present application;

FIG. 3 is an example of adding node H14 to a hash tree already containing 13 elements, according to one embodiment of the present application;

FIG. 4 is an example of reading nodes H7 and H12 from a hash tree already containing 13 elements, according to one embodiment of the present application;

FIG. 5 is an example of reading nodes H7 and H10 from a hash tree already containing 16 elements, according to one embodiment of the present application;

FIG. 6 is a schematic diagram of parallel processing in a hardware pipeline, according to one embodiment of the present application;

FIG. 7 is an example table showing the correspondence between different leaf nodes and complete concrete subtrees at various levels, according to one embodiment of the present application;

FIG. 8 is an example of parallel insertion of multiple leaves, according to one embodiment of the present application;

FIG. 9 is a schematic diagram of calculating in parallel two complete binary trees, each containing 64 leaf nodes, within one PE (Processing Element) in a pipelined manner, according to one embodiment of the present application;

FIG. 10 is a schematic diagram of the overall database design, according to one embodiment of the present application.

### DETAILED DESCRIPTION OF EMBODIMENTS

In the following description, numerous technical details are set forth in order to provide a thorough understanding of the present application. However, those skilled in the art can understand that the technical solution claimed in this application can be realized without these technical details and various changes and modifications based on the following embodiments.

### Explanation of Some Concepts

DDR (Double Data Rate) is a memory technology characterized by its ability to transfer data on both the rising and falling edges of a clock signal, thus achieving double the data transfer rate at the same clock frequency. This technology is widely used in computer system memory and graphics cards.

QLC (Quad-Level Cell) is a flash memory technology where each storage cell can store 4 bits of data (i.e., 16 different voltage states). Compared to traditional SLC, MLC, and TLC storage technologies, it offers higher storage density and lower cost, but also faces challenges of lower endurance and write speeds.

SCM (Storage Class Memory) is a new type of storage technology that combines the characteristics of both memory and storage. It integrates the high-speed access features of DRAM with the non-volatile characteristics of flash memory, allowing it to retain data when powered off and provide access speeds close to memory levels, filling the performance gap between traditional memory and storage devices.

LSB (Least Significant Bit) refers to the rightmost bit in a binary number, representing the smallest numerical unit.

TPS (Transactions Per Second) is a performance metric used to measure the processing capability of a system. It indicates the number of transactions that a system can complete per second and is often used to evaluate the performance of transaction-intensive applications such as databases and payment systems.

Highest Leaf Node refers to the leaf node in the binary hash tree whose serial number is the highest among all leaf nodes.

Concrete Node (or non-virtual node) refers to a node in the binary hash tree that actually stores a calculated hash value. Concrete nodes include two types: a) Concrete leaf node: A leaf node whose serial number is not greater than the current highest leaf node's serial number, and its value is the hash value of the corresponding data payload; b) Concrete parent node: A parent node whose child nodes are all concrete nodes, and its value is the result of calculating a hash value after concatenating the hash values of its two child nodes.

Virtual Node refers to a node in the binary hash tree that does not actually store a calculated hash value. Virtual nodes include two types: a) Virtual leaf node: A leaf node whose serial number is greater than the current highest leaf node's serial number, and its value is a preset value (e.g., a null value or a predefined specific value). This preset value can be distinguished from a normal hash value (e.g., a normal hash value will not be null value; null value is a 256-bit constant of all zeros), indicating that data has not yet been written into this position; b) Virtual parent node: A parent node with at least one child node being a virtual node. A virtual parent node does not store an independently calculated hash value. When its hash value is needed, the hash value of its single concrete child node is used directly. That is: if the left child node is a concrete node and the right child node is a virtual node, the hash value of the parent node is equal to the hash value of the left child node; if the right child node is a concrete node and the left child node is a virtual node, the hash value of the parent node is equal to the hash value of the right child node; if both child nodes are virtual nodes, the hash value of the parent node is the preset value (e.g., a null value or a predefined specific value).

Complete Concrete Subtree refers to a subtree in the binary hash tree that satisfies all of the following conditions: a) All nodes in the subtree (including leaf nodes and intermediate nodes) are concrete nodes; b) The subtree does not contain any virtual nodes; c) The subtree has a complete binary tree structure, i.e., the subtree contains 2 to the power of k leaf nodes, where k is a non-negative integer.

Root Set refers to an ordered set composed of the root nodes of all complete concrete subtrees, in order from left to right, when the hash tree contains N leaf nodes. The root set is used for quick verification and calculation of the global root hash value.

Global Root Hash refers to the final hash value obtained by calculating the hash values of the elements in the root set level by level from right to left, when the hash tree contains N leaf nodes. Proof Set refers to the minimum set of hash values used to verify the data integrity of a specific leaf node. This set contains the hash values of the paired nodes at each level on the path from the target leaf node to the proof target node.

Proof Target refers to the root node of the smallest complete concrete subtree that contains the target leaf node. This node must be an element of the root set.

In one embodiment, a data write method for a key-value database comprises the following steps:
a processor receiving a write request, the write request comprising key-value pair data;
the processor writing the key-value pair data as a data payload to a first memory;
the processor calculating a hash value of the data payload and writing the hash value to a binary hash tree stored in a fourth memory as a highest leaf node with a current largest serial number; wherein in the binary hash tree, serial numbers of respective leaf nodes increase in sequence, leaf nodes with serial numbers not greater than that of the highest leaf node are concrete nodes with values being hash values of corresponding data payloads, and leaf nodes with serial numbers greater than that of the highest leaf node are virtual nodes with values being a preset value;
the processor determining, in a direction from leaf nodes to a root node, whether respective parent nodes corresponding to the highest leaf node are located within a complete concrete subtree, wherein the complete concrete subtree is a subtree that does not contain any virtual nodes;
in response to determining that the parent node is located within the complete concrete subtree, treating the parent node as a concrete node, calculating a hash value of the parent node based on hash values of two child nodes of the parent node, and storing the hash value of the parent node into the fourth memory;
in response to determining that the parent node is not located within the complete concrete subtree, treating the parent node as a virtual node, and when needing to obtain a hash value of the parent node, directly using a value of its child node whose value is not the preset value as the hash value of the parent node.

This embodiment introduces the concepts of concrete nodes and virtual nodes into the binary hash tree, setting nodes with serial numbers not greater than the highest leaf node's serial number as concrete nodes and those with larger serial numbers as virtual nodes. It does not calculate or store the hash values of parent nodes that are virtual nodes. This can significantly reduce the number of hash calculations. This innovation avoids the problem of traditional Merkle trees requiring hash calculations for all nodes, improves data write efficiency, and simultaneously ensures the reliability of data verification.

Preferably, the above method may further comprise the following steps: multiple complete concrete subtrees are formed from left to right in the binary hash tree, and the processor adds the root nodes of the respective complete concrete subtrees to a root set; the processor obtains a global root hash value by calculating the hash values of the nodes in the root set level by level from right to left; the processor calculates a proof set, specifically comprising: starting from the leaf node, in order from lower levels to higher levels, at each level, if the current node is on the left side, searching for the hash value of its right-side paired node, or if the current node is on the right side, searching for the hash value of its left-side paired node, and adding the found hash value of the paired node to the proof set; the processor returns data for verifying the write operation to a requesting party device, the data comprising: the global root hash value, the root set, and the proof set.

By identifying multiple complete concrete subtrees from left to right, adding their root nodes to a root set, then calculating the hash values of the nodes in the root set level by level from right to left to obtain a global root hash value, while generating a proof set based on paired nodes, this technical solution achieves rapid verification of the data writing process. This layered verification mechanism not only reduces the computational complexity of verification but also provides fine-grained data integrity assurance.

Preferably, the requesting party device can verify the correctness of the write in the following manner: a proof target node is calculated based on the proof set and the hash value of the leaf node, wherein the proof target node is an element in the root set; and, it is possible to obtain the global root hash value by calculating the hash values of the respective elements in the root set level by level. By designing a dual verification mechanism (the proof target node must exist in the root set, and the global root hash value can be calculated from the root set), this provides a strict correctness guarantee for the data write operation. This verification method can effectively prevent data tampering, and the verification process has low computational overhead and high verification efficiency.

Preferably, the fourth memory comprises a second memory and a third memory. The first memory and the second memory are non-volatile memories; the access bandwidth (or access speed) of the first memory, the second memory, and the third memory increases sequentially. Nodes from level 0 to level N of the binary hash tree are stored in the second memory, wherein the nodes from level 0 to level N are organized into at least one complete subtree, and each said complete subtree is stored in one page of the second memory, with the storage space size of the complete subtree being the same as the size of the page; nodes at level N+1 and higher levels of the binary hash tree are stored in the third memory; wherein N is a preset positive integer. By adopting a tiered storage strategy, storing nodes from level 0 to level N of the binary hash tree in the second memory and higher-level nodes in the faster third memory, and matching complete subtrees to storage page sizes in the second memory, a reasonable allocation of storage resources is achieved. This tiered storage architecture fully considers the access characteristics of nodes at different levels, optimizes storage space utilization, and enhances data access performance.

Preferably, in each page of the second memory, nodes of each level of a complete subtree are stored level by level, from level 0 to level N; the serial number of the leaf node is directly used as its storage position at level 0; a one-to-one correspondence between node serial numbers and storage positions is maintained at each level. The processor comprises multiple parallel long SHA256 computation circuits and multiple parallel short SHA256 computation circuits, wherein the long SHA256 computation circuits are used to calculate, in parallel, the hash values of the respective leaf nodes in a page based on the data payloads, and the short SHA256 computation circuits are used to perform paired calculations on adjacent pairs of leaf nodes to obtain parent nodes at level 1, and then, through multi-way parallel computation level by level from bottom to top, finally converge to a single-way computation to obtain the root hash value of the complete subtree. By designing a processor architecture that includes multiple parallel long SHA256 computation circuits (for calculating leaf node hash values) and short SHA256 computation circuits (for calculating parent node hash values), combined with a node storage structure organized by levels, efficient parallel computation of hash values is achieved. This design significantly enhances hash computation performance and reduces data write latency.

Preferably, for a complete subtree that is from empty to half-full, a virtual root hash value for that complete subtree is calculated using virtual nodes. For a complete subtree that is from half-full to full, after being filled to become a full tree, the previously-used virtual nodes are discarded, and the hash values for the entire complete subtree up to the root are recalculated. By adopting a differentiated processing strategy for complete subtrees with different fill levels (using virtual nodes to calculate a virtual root hash value when empty to half-full, and recalculating the entire subtree's hash value when half-full to full), a good balance between computational overhead and storage efficiency is achieved. This dynamic adjustment strategy avoids frequent hash recalculations while ensuring data integrity.

Preferably, when batch writing key-value pair data, the following pipelined approach is used for processing: in a first pipeline stage, 64 key-value pair data items are read to form one complete subtree; in a second pipeline stage, 64 parallel SHA256 computation circuits are used to calculate the hash values of the 64 key-value pair data items as leaf nodes; in a third pipeline stage, 32 parallel SHA256 computation circuits are used to perform pairwise combination calculations on the leaf nodes, proceeding sequentially through 16-way parallel computation, 8-way parallel computation, 4-way parallel computation, 2-way parallel computation, and single-way computation, to obtain the hash values of the nodes at each level of the complete subtree; in a fourth pipeline stage, the node hash values of the complete subtree are written into one 4 KB page of the second memory. By designing a four-stage pipeline and employing varying degrees of parallel processing in each stage, efficient processing of batch read/write operations is achieved. This pipeline architecture fully utilizes hardware parallel computation resources and significantly increases system throughput. The following is an embodiment of a data read method for a key-value database. Key-value pair data is stored as data payloads with increasing serial numbers in a first memory, and a binary hash tree is stored in a fourth memory; wherein in the binary hash tree, each leaf position corresponds to a serial number, leaf nodes with serial numbers not greater than a maximum serial number of the data payloads in the first memory are concrete nodes with values being hash values of corresponding data payloads, and leaf nodes with larger serial numbers are virtual nodes with values being a preset value; for a parent node, if either of its child nodes is a virtual node, the parent node is a virtual node, and its value is equal to the value of its child node whose value is not the preset value, otherwise, the parent node is a concrete node, and its value is a result of a hash operation on its two child nodes; the method comprises: a processor receiving a read request from a requesting party device, and reading a requested data payload from the first memory, wherein a leaf node corresponding to the data payload is a target leaf node; the processor generating a proof set for the target leaf node, wherein elements in the proof set are hash values of paired nodes at each level on a path from the target leaf node to a proof target node in the binary hash tree; the proof target node is a root node of a smallest complete concrete subtree containing the target leaf node; the complete concrete subtree is a subtree that does not contain any virtual nodes; the processor returning the requested data payload and the proof set to the requesting party device. By optimizing the generation strategy for verification data, only the proof set from the target leaf node to the root of the smallest complete concrete subtree is returned, significantly reducing the amount of data required for verification. This solution reduces network transmission overhead, improves data read efficiency, and simultaneously ensures the reliability of the verification.

Preferably, the requesting party device verifies the correctness of the read data in the following manner: obtaining a global root hash value and a root set, wherein the global root hash value is the hash value of the root node of the binary hash tree, and the root set comprises the root nodes of multiple complete concrete subtrees from left to right in the binary hash tree; calculating a proof target node based on the proof set and the hash value of the target leaf node, wherein the proof target node is an element in the root set; and the global root hash value can be obtained by calculating the hash values of the respective elements in the root set level by level. In a preferred example, the processor determines the proof target node through the following steps: starting from the most significant bit of the serial number of the current highest leaf node of the binary hash tree, checking the corresponding complete concrete subtree; if the serial number of the target leaf node is less than or equal to the number of leaf nodes in the current complete concrete subtree, then the root node of the current complete concrete subtree is taken as the proof target node; if the serial number of the target leaf node is greater than the number of leaf nodes in the current complete concrete subtree, then the number of leaf nodes of the current complete concrete subtree is subtracted from the serial number of the target leaf node, and the check continues to the next significant bit's corresponding complete concrete subtree, until the complete concrete subtree containing the target leaf node is found.

Preferably, the step of the processor generating the proof set comprises: converting the serial number of the target leaf node to binary; establishing a level mapping, with the least significant bit corresponding to level 0; processing level by level starting from the target leaf node: checking the index value of the current node to determine if it is a left node or a right node, if it is a left node, calculating the serial number of the corresponding right-side paired node and adding the hash value of the paired node to the proof set, if it is a right node, calculating the serial number of the corresponding left-side paired node and adding the hash value of the paired node to the proof set, until the level of the proof target node is reached.

Preferably, the fourth memory comprises a second memory and a third memory; the first memory and the second memory are non-volatile memories; the access bandwidth of the first memory, the second memory, and the third memory increases sequentially. Nodes from level 0 to level N of the binary hash tree are stored in the second memory, wherein the nodes from level 0 to level N are organized into at least one complete subtree, and each said complete subtree is stored in one page of the second memory, with the storage space size of the complete subtree being the same as the size of the page; nodes at level N+1 and higher levels of the binary hash tree are stored in the third memory; wherein N is a preset positive integer.

Preferably, for a system where indexing starts from 1, the processor determines the path from the target leaf node to the proof target node using the following index-based hardware computation method:
convert the target leaf serial number to binary as the index for level 0;
in the processing of each level:
   determine the node type by checking the least significant bit: if the least significant bit is 1, it is a left node; if it is 0, it is a right node;
   for a left node, find the right-side paired node by adding 1; for a right node, find the left-side paired node by subtracting 1;
   obtain the corresponding index for the next higher level by a right shift operation of 1 bit;
repeat the above process until the level of the proof target node is reached.

Preferably, the processor employs a hardware pipeline structure to parallelly process read requests for multiple leaf nodes, comprising: first processing resources for calculating in parallel the indices at various levels for multiple target leaf nodes using bitwise operations; second processing resources for reading, in parallel, nodes from level 0 to level 6 from multiple 4 KB pages in the second memory and extracting the nodes belonging to the proof sets; third processing resources for reading, in parallel, nodes belonging to the proof sets from level 7 to the root node, corresponding to the multiple target leaf nodes, from the third memory; fourth processing resources comprising multiple parallel SHA256 computation circuits for calculating in parallel the hash values of multiple verification paths and returning the complete proof sets.

Preferably, the processor comprises hardware acceleration circuits for calculating SHA256 hash values. The hardware acceleration circuits comprise: multiple parallel long SHA256 computation circuits for calculating the hash values of data payloads; multiple parallel short SHA256 computation circuits for calculating the hash values of nodes on the verification paths; wherein the processor supports the simultaneous use of multiple SHA256 computation circuits in parallel during the verification process.

Embodiments of the present application introduce the concepts of concrete nodes and virtual nodes into a binary hash tree. In this binary hash tree, each leaf position corresponds to a serial number. Leaf nodes with serial numbers not greater than the maximum serial number of data payloads in the key-value database are concrete nodes, with their values being the hash values of the corresponding data payloads. Leaf nodes with larger serial numbers are virtual nodes, with their values being a preset value. The preset value can be a null value or a predefined identification value, as long as it can be distinguished from a normal hash value. For example, a 256-bit constant of all zeros can be used as the preset value, or a 256-bit constant randomly generated and published during system initialization, to be distinguished from normal SHA256 outputs in the hash verification protocol. For a parent node, if either of its child nodes is a virtual node, the parent node is a virtual node, and its value is equal to the value of its non-null-value child node; otherwise, the parent node is a concrete node, and its value is the result of a hash operation on its two child nodes. The hash values of parent nodes that are virtual nodes are neither calculated nor stored. That is, only parent nodes within a complete concrete subtree need to have a new hash value calculated; parent nodes not in a complete concrete subtree can directly copy the value of their non-null-value child node. This mechanism significantly reduces the number of hash calculations and improves write efficiency.

Embodiments of the present application also propose an efficient data verification solution:
designing a mechanism to form multiple complete concrete subtrees from left to right and establish a root set; reducing the amount of verification data by generating a minimal proof path (only containing the path from the target leaf node to the root of the smallest complete concrete subtree);
adopting a dual verification mechanism (the proof target node must be a root set element, and the global root hash value can be calculated from the root set). These designs reduce verification overhead while ensuring data integrity.

Embodiments of the present application also propose an optimized storage architecture: adopting a three-level memory architecture, allocating nodes of different levels to memories of different speeds based on access characteristics; matching complete subtrees to the storage page size of solid-state drives to optimize storage space utilization. This tiered storage strategy enhances data access efficiency.

Embodiments of the present application also propose high-performance hardware acceleration designs, including: designing multiple parallel long and short SHA256 computation circuits; adopting a four-stage pipeline architecture to process batch read/writes; implementing fast index calculation based on hardware, and so on. These hardware optimizations significantly enhance system performance.

To make the objectives, technical solutions, and advantages of the present application clearer, the embodiments of the present application will be described in further detail below with reference to the accompanying drawings.

In one embodiment, an implementation method for a verifiable key-value database comprises:

Implementing an improved Merkle Shrubs hash tree structure in hardware, which is based on sequential writes and random reads to achieve maximum storage bandwidth and storage lifespan.

Data payloads are written into a first memory using a journaling method, serialized transactions are written into a second memory, and a part of the Merkle Shrubs is written into the second memory, while another part is written into a third memory. Optionally, the first memory can use QLC flash, the second memory can use SCM, and the third memory can use DDR. The first, second, and third memories can also use other types of memory, as long as the following conditions are met:

The first memory is a non-volatile memory, and the second memory is a non-volatile memory; the third memory can be a volatile memory (or it can also be a non-volatile memory).

In terms of access bandwidth: First memory<Second memory<Third memory.

The design of the aforementioned memory types primarily considers the optimal trade-off between performance and cost.

Real-time verification of write transactions is implemented as follows: after writing key-value data, the database returns a root hash value and a sequence of verification hash values. The verification method is: concatenate the hash value of the written data with the proof hash values, and calculate to obtain the root hash value using a public, fixed algorithm. After this, when any read operation is performed, the root hash value returned by the database remains unchanged, still being the root hash value from when the write transaction was completed. All read operations can be verified using this root hash value.

With the support of a Trusted Execution Environment (TEE) and certified firmware, the verification of write transactions can be simplified: the TEE returns its signed verification data packet, which contains an attested timestamp, a monotonically increasing sequence number, a transaction hash value, and verification hash values of the transaction.

Real-time verification of read transactions is implemented as follows: before a read operation, the client first obtains the latest root hash value pushed by the database. If there are no write operations, this root hash value remains unchanged. After reading the data, the database returns the data content and a sequence of verification hash values. The verification method is: concatenate the hash value of the data with the proof hash values, and calculate to obtain the root hash value using a public, fixed algorithm.

This solution solves a core problem in traditional solutions: during database read/write transactions, the search and computation speed of proof hash values is much slower than the read/write speed of data payloads. This solution provides a parallel computation scheme, allowing the database's Transactions Per Second (TPS) to no longer be limited by storage bandwidth, but instead to increase linearly with the addition of parallel SHA256 computation units.

At the same time, this solution provides a cost-effective TEE solution: comprising a TEE computing core with certified firmware, protected DDR memory, and protected non-volatile memory (NVM). A large volume of data payloads is stored in low-cost NVM outside the TEE.

This implementation scheme is extremely secure mathematically: it is difficult for a malicious attacker to forge a set of proof hash values and a root hash value that passes verification by the public, fixed algorithm without actually writing a transaction. Similarly, in a read operation, it is also difficult to forge a sequence of verification hash values for specific returned data that would result in the correct root hash value through the public, fixed algorithm.

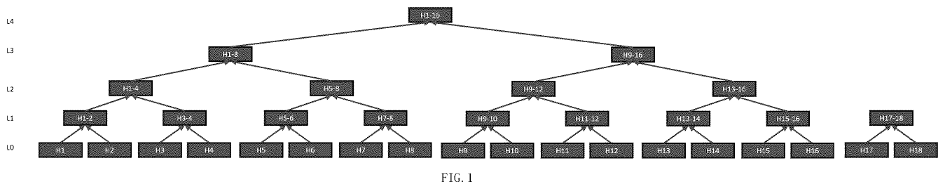

This embodiment adopts an improved Merkle Shrubs hash tree structure, which computes and stores fewer intermediate nodes than a traditional Merkle Tree, thereby improving computation efficiency. Referring to FIG. 1, the specific implementation is as follows:

In this hash tree structure, a leaf node Hx represents the SHA256 hash value of the data payload of the transaction with serial number x. Among these, Insert and Update transactions correspond to the hash value Hx of a standard key-value pair {K:V} payload, while Delete and Hide transactions correspond to the hash value of a special {K:Null} payload. This structural design ensures that the entire improved Merkle Shrubs tree only supports two basic operations: append and read.

Transaction serial numbers increase monotonically, and transactions in the database continuously accumulate, where x in Hx represents the transaction serial number. Intermediate nodes are represented, for example, as H1-2, which represents the SHA256 hash value obtained by concatenating H1 and H2 and then computing the hash.

For convenience of expression, the following two basic operators are defined in this application:
The “→” operator represents a fixed algorithm that sequentially concatenates the elements in the SHA256 set on the left and calculates the SHA256 level by level, with the result being the value on the right;
The “+{ }” operator represents sequentially adding the elements on the left to the ordered set on the right.

When writing a transaction with serial number x, the user writes Data(x), and the database returns a GlobalRoot(x), a RootSet(x), and a ProofSet(x). The user verifies by calculating Hx+{ProofSet(x)}→W, where W should be an element in RootSet(x). To improve security, it is also necessary to verify RootSet(x)→GlobalRoot(x), especially when x is an odd number, because Hx itself is an element of RootSet(x) at that time. In the embodiments of the present application, the user refers to the requesting party device. The requesting party device is generally a computer device, including a processor (connected to memory, hard disk, and communication interfaces via a bus), and is configured to send requests, obtain feedback results from the processor, and verify the correctness of the feedback results.

When reading a transaction with serial number y (y<x), the user holds GlobalRoot(x) and RootSet(x), and the database returns Data(y) and ProofSet(y). The user verifies by calculating Hy+{ProofSet(y)}→Z, where Z should be an element in RootSet(x). It is also necessary to verify the calculation process of RootSet(x)→GlobalRoot(x), especially when y and x are close to each other (e.g., log₂(x-y)<10), as the resistance to interference is lower at this time. The GlobalRoot(x) and RootSet(x) used for data read verification can be obtained from a reliable source, for example, the global root hash value and root set returned upon a previous write (it must be ensured that the data being read this time was already in the key-value database at the time of that write), or they can be obtained from a reliable third party, or they can be provided by the key-value database at the time of reading.

This embodiment adopts a left-to-right full tree design. To facilitate hardware acceleration implementation, it is required that each level maintains an independent one-dimensional array, ArrayIndex. In a specific implementation, the 64-node full tree from L0 to L6 all use 4 KB-sized SCM storage units. This storage method facilitates direct data transfer to DDR without requiring bit-shifting operations.

The write operation implementation for the improved Merkle Shrubs hash tree is further explained below. This is illustrated through specific examples:

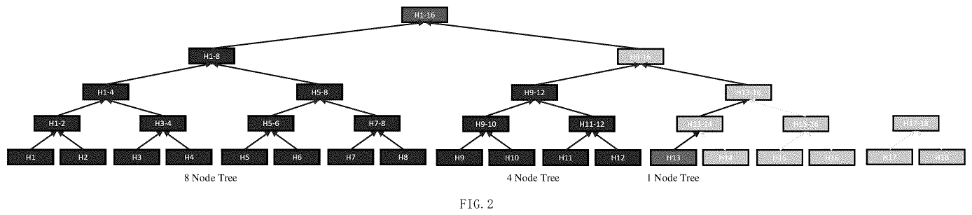

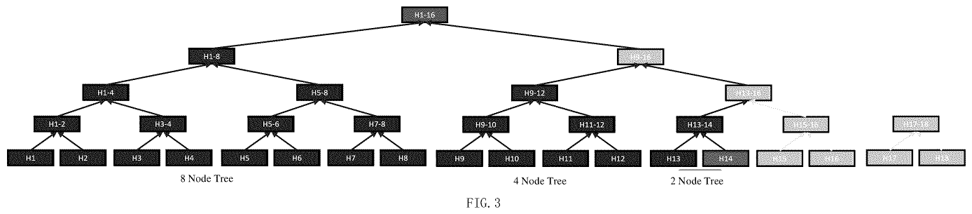

As shown in FIG. 2, when H13 is appended:
The system generates a virtual global root hash GlobalRoot(13), which is the virtual H1-16. The corresponding RootSet(13) contains three elements: H1-8, H9-12, and H13. The ProofSet(13in13) is its own RootSet. (a in b) in the embodiments of the present application represents the a-th node in a hash tree with a total of b nodes. For a quick verification, it is only necessary to confirm that H13 exists in RootSet(13); for a full verification, it is necessary to calculate SHA256(H1-8, SHA256(H9-12, H13)) and verify that it equals GlobalRoot(13). Since 13 is an odd serial number, its RootSet consists of a series of the highest concrete tree roots from left to right, as well as the node itself. As shown in FIG. 3, when H14 is appended:
The system generates a virtual global root hash GlobalRoot(14), which is the virtual H1-16. The corresponding RootSet(14) contains: H1-8, H9-12, and H13-14. Its ProofSet(14in14) contains only H13. For a quick verification, calculate SHA256(H13, H14) and verify that it equals H13-14; for a full verification, calculate SHA256(H1-8, SHA256(H9-12, SHA256(H13, H14))) and verify that it equals GlobalRoot(14). Since 14 is an even serial number, its RootSet consists of a series of the highest concrete tree roots from left to right, and its ProofSet is the RootSet corresponding to the serial number minus one.

This embodiment introduces the concept of virtual nodes and replaces the SHA256 calculation for virtual nodes with a simple copy operation. This is fundamentally different from traditional Merkle Tree implementations: in a traditional implementation, each upper-level node is a concrete node. For example, when writing H13, H13-14 must exist as a concrete node and be actually copied and stored, and when writing H14, the value of H13-14 needs to be overwritten. By introducing virtual nodes, overwrite operations on the tail nodes of each level can be avoided.

After the append-write operation is completed, several concrete trees whose sizes are powers of 2 are formed from left to right. The root nodes of these concrete trees are combined from right to left, ultimately forming a virtual overall root node of the tree. Through this design, storage and computation overhead are significantly reduced.

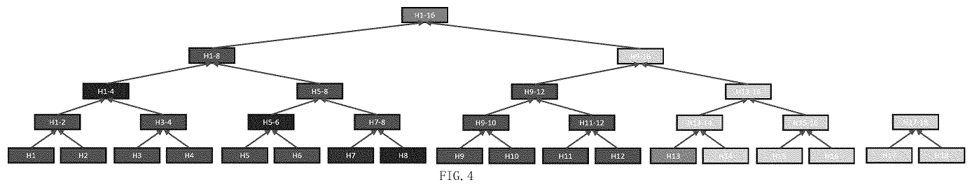

The read operation implementation for the improved Merkle Shrubs hash tree is further explained below:
Referring to FIG. 4 (wherein the light-colored nodes (e.g., H14 to H18, H13-14, H15-16, H17-18, H13-16, H9-16) are virtual nodes, and H1-16 is the virtual overall root node of the tree), when the current highest leaf node is H13, the process of reading H7 is as follows:
GlobalRoot(13) is obtained by calculating SHA256(H1-8, SHA256(H9-12, H13)), and the corresponding RootSet(13) contains H1-8, H9-12, and H13. The system determines that ProofTarget(7in13) is H1-8 and generates ProofSet(7in13) containing H1-4, H5-6, H7, and H8. For a quick verification, calculate SHA256(H1-4, SHA256(H5-6, SHA256(H7, H8))) and verify that it equals H1-8. For a full verification, on top of the quick verification, further verify whether GlobalRoot(13) can be calculated from RootSet(13).

Referring to FIG. 4, when the current highest leaf node is H13, the process of reading H12 is as follows:
GlobalRoot(13) is obtained by calculating SHA256(H1-8, SHA256(H9-12, H13)), and the corresponding RootSet(13) contains H1-8, H9-12, and H13. The system determines that ProofTarget(12in13) is H9-12 and generates ProofSet(12in13) containing H9-10, H11, and H12. For a quick verification, calculate SHA256(H9-10, SHA256(H11, H12)) and verify that it equals H9-12. For a full verification, on top of the quick verification, further verify whether GlobalRoot(13) can be calculated from RootSet(13).

The generation rule for the ProofSet is as follows: starting from the target leaf node, search for the paired node at each level in order from lower levels to higher levels. If the current node is on the left side, search for its right-side paired node; if it is on the right side, search for its left-side paired node. The ProofTarget is defined as: in the RootSet of the highest appended leaf, the root node of the complete concrete tree that directly contains the target read leaf.

The Proof (verification process) is as follows: start from the read leaf node and build upwards level by level. At each level, find the paired node based on the node's position (left finds right, or right finds left), concatenate the paired nodes in order, and calculate the SHA256 to get the node for the next higher level. Repeat this process until the root node of a complete concrete tree is reached.

The verification mechanism for virtual nodes is further explained below:

Taking the case where the tree has accumulated to H13 and H7 needs to be verified as an example: When the tree has accumulated to H13, the GlobalRoot for the entire tree is the virtual H1-16. It should be noted that the real H1-16 will only appear when H16 is also written into the tree. Since H14 to H16 have not yet been written, the RootSet(13) corresponding to H13 contains three elements: H1-8, H9-12, and H13.

The calculation process for the virtual root node H1-16 adopts a hierarchical virtual node processing method:

First, the virtual H1-16 is calculated as SHA256(H1-8+virtual H9-16); wherein, the virtual H9-16 is calculated by SHA256(H9-12+virtual H13-16); the virtual H13-16 is calculated by SHA256(virtual H13-14+virtual H15-16); since H14 is a virtual node (null value), the virtual H13-14 does not require SHA256 calculation and is directly equal to H13; the virtual H15-16 is calculated by SHA256(virtual H15+virtual H16), and since both H15 and H16 are null values, H15-16 is also null value.

In summary, the final calculation of the virtual H1-16 is simplified to: SHA256(H1-8+SHA256(H9-12+H13)). This calculation process actually reflects the SHA256 calculation of the path from the rightmost node H13 to the virtual root. This design significantly reduces the number of SHA256 calculations compared to the original Merkle Tree structure, improving computation efficiency.

The calculation process of the ProofSet is further explained below, illustrated by two examples of reading H7 and H10 where the leaf node with the highest serial number is H16:

Referring to FIG. 5, when reading H7: At this time, GlobalRoot(16) is the concrete H1-16, RootSet(16) contains only H1-16, and ProofTarget(7in16) is H1-16. The ProofSet(7in16) generated by the system contains H1-4, H5-6, H7, H8, and H9-16.

Referring to FIG. 5, when reading H10: GlobalRoot(16) and RootSet(16) remain unchanged, and ProofTarget(10in16) is H1-16. The ProofSet(10in16) generated by the system contains H9, H10, H11-12, H13-16, and H1-8.

To facilitate hardware implementation, this embodiment adopts a node representation method based on an Index at each level. Taking the calculation of the ProofSet for the target leaf H7 as an example, the left-to-right Index calculation process is detailed as follows:
The target leaf serial number x=7 (binary 111b) has an Index of 111b at the L0 level. The detailed calculation steps are as follows:
Step 1: At the L0 level, 111b is a left node, need to find the right node, 111b+1=1000b=8. So the right node found is H8. Push H8 into the ProofSet.
Step 2: At the L0 level, the left and right nodes are concatenated and SHA256 is calculated. Then, find the position of this calculation result at the L1 level (calculate using the right node). Right shift 1000b by one bit to get 100b=4. (The method for calculating the Index of their corresponding intermediate node in the upper level, from the Index of the right node of this pair of leaf nodes in the L0 level, is a simple right shift by one bit. This design is also for hardware convenience. The calculation result is H7-8, represented by its index=4 at the L1 level.)
Step 3: At the L1 level, 100b is a right node, need to find the left node, 100b-1=11b. So the left node found is H5-6. Push H5-6 into the ProofSet. (Similarly, H5-6 is represented by its index=11b=3 at the L1 level.)
Step 4: At the L1 level, the left and right nodes are concatenated and SHA256 is calculated. Then, find the position of this calculation result at the L2 level (calculate using the right node). Right shift 100b by one bit to get 10b.
Step 5: At the L2 level, 10b is a right node, need to find the left node, 10b-1=1b. Push H1-4 into the ProofSet (H1-4 is represented by its Index=1b=1 at the L2 level).
Step 6: At the L2 level, the left and right nodes are concatenated and SHA 256 is calculated. Then, find the position of this calculation result at the L3 level (calculate using the right node). Right shift 10b by one bit to get 1b.
Step 7: At the L3 level, 1b is a left node, need to find the right node, 1b+1=10b. Push H9-16 into the ProofSet (H9-16 is represented by its index=10b=2 at the L3 level).
Step 8: At the L3 level, the left and right nodes are concatenated and SHA256 is calculated. Then, find the position of this calculation result at the L4 level (calculate using the right node). Right shift 10b by one bit to get 1b.
Step 9: Level L4 is reached. This is a concrete root of the highest leaf H16, i.e., an element in the RootSet of the highest leaf has been reached, thus successfully completing the pushing of elements into the ProofSet.

This Index-based design significantly simplifies hardware implementation, as all operations can be completed through simple bitwise operations. Embodiments of the present application use a node serial number system starting from 1, wherein: if the LSB (Least Significant Bit) is 1, it is determined to be a left node (odd serial number); if the LSB is 0, it is determined to be a right node (even serial number); a left node finds its right-side paired node by adding 1, and a right node finds its left-side paired node by subtracting 1. A person skilled in the art can understand that a 0-based indexing system can also be used (converted by subtracting 1 from the serial number). In a 0-based system, even indices are left nodes and odd indices are right nodes, which is functionally equivalent to the 1-based system of the present application.

The performance characteristics of the above embodiments are analyzed as follows:

### Read Transaction Performance Characteristics

The complete hash tree from L0 to the root node is already computed and stored in SCM and DDR at the time of data writing. Therefore, the ProofSet returned by a read transaction is directly read from the existing tree structure, requiring no recalculation. The read transaction's IOPS (Input/Output Operations Per Second) is mainly limited by the speed of retrieving the L0-level leaf hash value and its corresponding ProofSet from SCM and DDR. Analysis and verification show that the TPS (Transactions Per Second) for reading a transaction's ProofSet is approximately equal to the random read IOPS of a 4 KB SCM page.

### Write Transaction Performance Characteristics

The write process needs to calculate the L0-level leaf hash value corresponding to the data, as well as the entire tree up to the virtual (or concrete) root hash. Specifically: for a tree with 10⁹ leaf nodes, its height ranges from L0 to L30; for a tree with 10⁷ leaf nodes, its height ranges from L0 to L24; in the best case, only 1 hash value needs to be calculated (the rest are virtual copies of virtual nodes); in the worst case, the computations from leaf to root need to be performed 30 times (for the tree with 10⁹ leaf nodes) or 24 times (for the tree with 10⁷ leaf nodes); the best-to-worst cases are uniformly distributed, requiring, on average, the calculation of hash values for half the tree height.

Factors constraining the write transaction TPS include:
1. The parallel processing capability for long SHA256 computations: calculating a 32-byte leaf node hash value from 1 KB of data.
2. The parallel processing capability for short SHA256 computations for an average of half the height of the tree structure from leaf node to root node (a 50% reduction in computation compared to traditional Merkle Trees).
3. Data writing using the sequential APPEND method to NAND flash.
4. Sequential APPEND writing of each 64-node full tree (from L0 to L6) of the hash tree to a 4 KB SCM page.
5. Hash tree levels L7 to the root are temporarily stored in DDR (bandwidth is significantly higher than the aforementioned factors, thus not a bottleneck for now).

The overall write performance is determined by the minimum bandwidth among the above factors.

To achieve K TPS write performance, the system needs:
K TPS of long SHA256 computation capability
15*K TPS of short SHA256 computation capability

From this, it is clear that the write transaction TPS is linearly related to the processing capability of the parallel SHA256 computation engine.

In one embodiment, a hardware pipeline structure supporting the parallel reading of multiple leaf nodes is used to simultaneously process ProofSet retrieval operations for multiple leaf nodes.

The verification process for each leaf node follows a uniform pattern:
First, obtain the node hash value;
Read the hash value of the paired node at the same level;
Concatenate the two hash values and compute the hash value for the upper-level node;
Repeat the above “read-compute” operations according to the dependency graph until a predefined root node is reached.

Based on storage hierarchy characteristics, the system divides the read operation into two parallelly executed parts: the 64-node full tree from L0 to L6 is stored in a 4 KB page of SCM; nodes at L7 and above are stored in DDR.

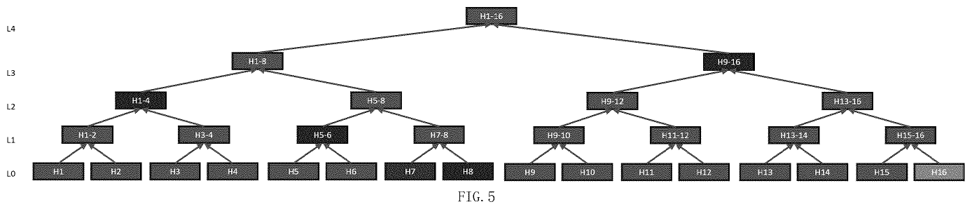

The parallel processing structure of the hardware pipeline is shown in FIG. 6, where each column in FIG. 6 is a time slice.

The processing for each leaf node is divided into four processing steps, with each processing step handled in one processing resource. That is:
Processing Resource 1: Quickly calculate indices for each level (Step 1);
Processing Resource 2: Read relevant pages from SCM for L0-L6 and extract ProofSet nodes (Step 2);
Processing Resource 3: Simultaneously read ProofSet nodes from L7 to the root from DDR (Step 3);
Processing Resource 4: Return the L0 value of that leaf node and the complete ProofSet (Step 4).

Different leaf nodes (e.g., Leaf 1 to Leaf 3 in FIG. 6) are processed sequentially by Processing Resources 1-4, but they are staggered in terms of timing. For example, when Processing Resource 3 is processing Step 3 for Leaf 1, Resource 2 is processing Step 2 for Leaf 2, and Resource 1 is processing Step 1 for Leaf 1.

Preferably, because the reading is done from different memories (SCM and DDR) respectively, Processing Resource 2 and Processing Resource 3 can be further parallelized, i.e., Step 2 and Step 3 can be processed simultaneously.

The performance of this pipeline design is mainly limited by the random read IOPS of 4 KB pages in SCM, with no additional SHA256 computation overhead. Through the parallel processing mechanism, the system can simultaneously handle ProofSet retrieval requests for multiple leaf nodes, significantly enhancing overall read performance.

A hardware computation acceleration scheme for the RootSet of the highest leaf node in one embodiment is described below. The key points of this scheme are as follows:

Node addressing scheme: Nodes at each level are numbered starting from 1; the serial number of a leaf node directly corresponds to its storage position at the L0 level; a one-to-one correspondence between serial numbers and storage positions is maintained at all levels.

Take the node with serial number 11 (H11) as an example. Since the serial number 11 is less than 16, it has not filled a 16-node tree; since the serial number is greater than 8, H1 to H8 have already filled an 8-node full tree; H9 to H10 fill a 2-node full tree; H11 individually fills a 1-node full tree; finally, an 8-node full tree, a 2-node full tree, and a 1-node full tree structure are formed from left to right.

This structure corresponds to the bit pattern of decimal 11 (binary 1011b). Among these, the bits from high to low correspond to full trees of different sizes; the root node of each full tree is located at an odd-numbered position of the corresponding level; L3, L1, and L0 are the bit-value-present levels (the levels corresponding to 1s in binary 1011b).

The root of the 8-node full tree is at L3@1 (1st unit at L3 level); the root of the 2-node full tree is at L1@5 (5th unit at L1 level); the root of the 1-node full tree is at L0@11 (11th unit at L0 level). The serial number at each level is exactly the truncation of the progressively lengthening string starting from the highest value bit.

The L2 level is a bit-value-absent level (the level corresponding to 0 in binary 1011b), and the truncated result is (10)b. This is not the root of a full tree.

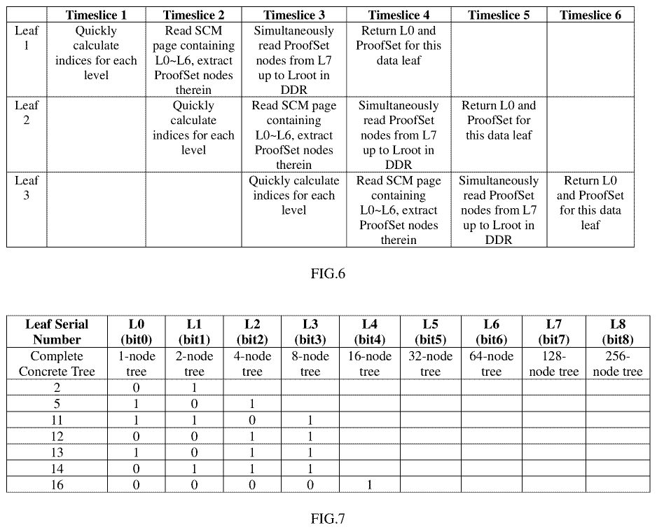

For the highest leaf node with serial number x, its RootSet is calculated as follows:
1. Convert the target serial number x to its binary representation.
2. Process starting from the most significant bit (MSB):
   Determine the corresponding level number based on the position (see FIG. 7 for the one-to-one mapping method);
   Check the value of this bit (1 or 0);
   If it is 1, the unit at index=1 of this level is a RootSet element; if it is 0, this level has no RootSet element.
3. Process the next most significant bit:
   Take the MSB-1 and MSB two bits;
   Determine the level number based on the MSB-1 position (see FIG. 7 for the one-to-one mapping method);
   If the MSB-1 bit is 1, the unit at the index equal to the value formed by these two bits at this level is a RootSet element; if the MSB-1 bit is 0, this level has no RootSet element.
4. Repeat the above process until all bits are processed.

The above calculation method can be processed in parallel, i.e., all bits from MSB to LSB can be processed simultaneously, thereby improving calculation efficiency.

A calculation method for the ProofTarget in one embodiment is described below, which aims to determine the ProofTarget of a target leaf node from the RootSet of the highest leaf node.

### Calculation Principle

Check the complete concrete subtree set (RootSet) of the highest leaf node in order from left to right (from high to low).
Start the search from the most significant bit of the highest leaf node's serial number.

### The Calculation Flow is Divided Into Two Cases

Case 1: The target leaf node is located within the current complete concrete subtree
   Judgment condition: The target leaf node's serial number is less than or equal to the number of leaf nodes in the current complete concrete subtree.
   Processing method: Directly use the root node of the current complete concrete subtree as the ProofTarget.
   Example (13 in 16): Target leaf node serial number is 13, highest leaf node serial number is 16 (binary 10000b); the 4th bit is 1, corresponding to a 16-node full tree; 13 is less than 16, therefore the root node of the 16-node full tree (L4@1) is the ProofTarget.
Case 2: The target leaf node's serial number exceeds the range of the current complete concrete subtree
   Judgment condition: The target leaf node's serial number is greater than the number of leaf nodes in the current complete concrete subtree.
   Processing method:
      Subtract the number of leaf nodes of the current complete concrete subtree from the target leaf node's serial number;
      Continue to check the complete concrete subtree corresponding to the next significant bit.
   Example (13 in 14):
1. First, check the most significant bit L3 of the highest leaf node 14 (8-node full tree);
   13 is greater than 8, execute 13−8=5.
2. Check the next significant bit L2 (4-node full tree);
   5 is greater than 4, execute 5−4=1.
3. Check the next significant bit L1 (2-node full tree);
   1 is less than 2, determine the ProofTarget to be the 2-node full tree of 14;
   The index value of the root in the L1 level is 111b;
   Index value calculation method: Take the binary value formed by the position of the level corresponding to the 2-node full tree of the highest leaf node 14 (L1) and all bits above it.

This design method supports efficient hardware implementation. By comparing and calculating level by level, the ProofTarget for any target leaf node can be quickly determined.

In one embodiment, a method for generating an instruction sequence to calculate the ProofSet when the ProofTarget is known is as follows. Take ProofTarget(13 in 16) as an example:

### Initialization Process

Convert the leaf serial number to binary (13=1101b);
Confirm the target ProofTarget is at L4@1;
Establish level mapping: least significant bit corresponds to L0, sequentially upwards to L4.

### ProofSet Construction Steps

1. Initialization: Insert the target leaf node {L0@13}.
2. L0 level processing:
   Detect 1101b as an odd left subtree;
   Calculate the corresponding even right subtree serial number 1110b (14);
   Insert the right node, forming {L0@13, L0@14};
   Right shift 1110b to get 111b as the L1 level serial number.
3. L1 level processing:
   Detect 111b as an odd left subtree;
   Calculate the corresponding even right subtree serial number 1000b (8);
   Insert the right node, forming {{L0@13, L0@14}, L1@8};
   Right shift 1000b to get 100b as the L2 level serial number.
4. L2 level processing:
   Detect 100b as an even right subtree;
   Calculate the corresponding odd left subtree serial number 11b (3);
   Insert the left node, forming {L2@3, {{L0@13, L0@14}, L1@8}};
   Right shift 100b to get 10b as the L3 level serial number.
5. L3 level processing:
   Detect 10b as an even right subtree;
   Calculate the corresponding odd left subtree serial number 1b;
   Insert the left node, forming {L3@1, L2@3, {{L0@13, L0@14}, L1@8}}};
   Right shift 1b to get 0b.
6. L4 level is reached (the level where ProofTarget is located), calculation completed.

### Instruction Sequence Optimization

1. Basic instruction sequence:
{Push L0@13 onto stack,
Push L0@14 onto stack then right-combine compute,
Push L1@8 onto stack then right-combine compute,
Push L2@3 onto stack then left-combine compute,
Push L3@1 onto stack then left-combine compute,
Compare stack top with ProofTarget}
2. Simplified instruction sequence:
{Start: Data(L0@13),
Right: Data(L0@14),
Right: Data(L1@8),
Left: Data(L2@3),
Left: Data(L3@1),
Compare: Data(L4@1)}

### Optimization Features

Supports reading only SHA256 values, postponing the combined computation to the client side.
Utilizes node index parity to directly correspond to left-combine/right-combine operations.
Suitable for the hierarchical design of a complete binary tree with 64 leaf nodes; hierarchical scheduling during instruction execution follows the established scheme.
Supports flexible generation of instruction sequences, e.g., ProofSet(14in16) can generate a corresponding optimized instruction sequence.

This design method achieves efficient hardware acceleration and instruction optimization while ensuring correctness.

In one embodiment, the ProofSet is calculated using a short computation when the ProofTarget is known. Take calculating ProofSet(13) when ProofTarget(13 in 14) is known as an example:

Convert the target leaf serial number to binary (13=1101b), confirm the ProofTarget is at L1@7, and establish level mapping: least significant bit corresponds to L0, upwards to L1 (the level where ProofTarget is located).

### ProofSet Construction Steps

1. Insert the target leaf node {L0@13}.
2. L0 level processing:
   Detect 1101b as an odd left subtree;
   Calculate the corresponding even right subtree serial number 1110b (14);
   Insert the right node, forming {L0@13, L0@14};
   Right shift 1110b to get 111b as the L1 level serial number.
3. L1 level processing:
Detect that the ProofTarget's level has been reached;
Verify that 111b (7) equals the ProofTarget serial number;
Calculation completed.

### Simplified Instruction Sequence

{Start: Data(L0@13),
Right: Data(L0@14),
Compare: Data(L1@7)}

In one embodiment, the virtual GlobalRoot is calculated level by level in a right-to-left order. Specifically: starting from the two rightmost elements of the RootSet, the SHA256 hash value is calculated level by level until all elements are processed.

Adopting a reverse processing order can match the previous algorithm design, because the RootSet construction process is progressively pushed from the highest level of the tree to the lowest level (e.g., using a stack). This order maintains computational continuity and data locality, ensuring the correct combination order of virtual nodes. This design method coordinates with the data flow of the entire system, effectively supports the processing mechanism of virtual nodes, and maintains computational efficiency.

In one embodiment, it is further optimized for the parallel insertion of multiple leaf nodes. Parallel insertion can omit the calculation of unnecessary VirtualGlobalRoots.

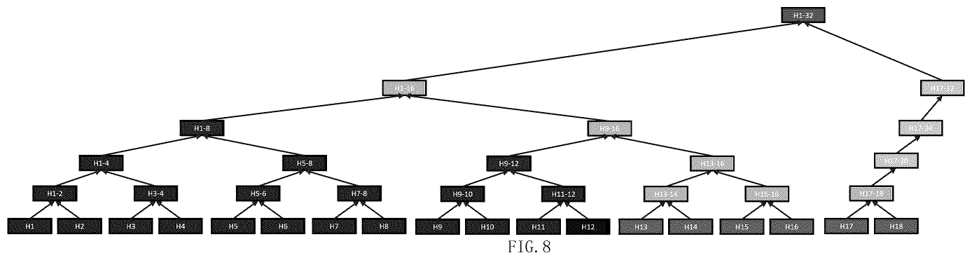

FIG. 8 shows an example where H12 is ready, and H13˜H18 are being written.

Corresponding to the hierarchical layering of a complete binary tree with 64 leaf nodes in SCM, the design is as follows:

From L0 Level to L6 Level:
When a complete binary tree with 64 leaf nodes goes directly from empty to full, the calculation of the entire tree is first completed in DDR, and then it is stored in SCM.
When a complete binary tree with 64 leaf nodes goes from empty to half-full, the virtual node design is still used in DDR to calculate the virtual root of this tree. It is not written into disk unless there is an emergency, such as power loss.
When a complete binary tree with 64 leaf nodes goes from half-full to full, after being filled to a full tree in DDR, the previously-used virtual nodes are discarded, and the entire complete binary tree with 64 leaf nodes is recalculated up to the root.

From L7 level to Lroot level: Calculate the GlobalRoot according to virtual nodes.

Here, “from empty to half-full” means the number of concrete leaf nodes in the complete subtree is less than or equal to half of the maximum number of leaf nodes in that complete subtree; “from half-full to full” means the number of concrete leaf nodes is greater than half of the maximum number of leaf nodes in that complete subtree and less than or equal to the maximum number of leaf nodes.

Compared to inserting only one leaf node, inserting multiple leaf nodes means that multiple upper-level nodes are transformed from virtual nodes (copy-type) to nodes that need to be actually calculated.

Generally, the length of the data payload is greater than the length of the SHA256 value. Therefore, the calculation at the L0 level is slower than the calculations at L1 and higher levels. So, an intuitive scheduling is to first read the tail of L0, then complete the calculation of the entire L0 level (calculate pair by pair from left to right, then append-write). Then, read the tail of L1 and complete the calculation of the entire L1 level. And so on for higher levels. The calculation and throughput model for each level starting from L1 is: (optionally) read from the tail, compute in pairs, append-write the result to the upper level. Compute the next pair, append-write the result to the upper level, until there are no new units in this level. Compared to the pattern above, the calculation and throughput model for the L0 level is: first calculate each new unit of this level (L0) from the data payloads, then process it in the same way as in the L1 level. This embodiment can write multiple back-to-back results within one level at once, and because multiple SHA256 results are needed to fill a NAND page, this solution can better leverage the write advantages of NAND.

Below is an analysis of the hardware bottleneck problem during database write transactions, using an example.

According to embodiments of the present application, with L0 to L6 in 4 KB pages of SCM and L7 to Lroot (the level where the tree root is) in DDR, storage bandwidth is no longer the bottleneck.

The computation load for a complete binary tree with 64 leaf nodes includes 64 long SHA256 operations, and 32, 16, 8, 4, 2, and 1 short SHA256 operations performed sequentially. Here, long SHA256 refers to calculating SHA256 from the usually longer original data, and short SHA256 refers to calculating the SHA256 of a higher-level node from the SHA256 of lower-level nodes. Theoretically, by preparing parallel computation resources for 64 long SHA256 and 63 short SHA256, it is possible to (pipeline) parallelly compute 2 complete binary trees, each with 64 leaf nodes.

The system can be equipped with several processing units, each processing unit having 64 parallel long SHA256 computation circuits and 32 parallel short SHA256 computation circuits. The computation circuits here can be hardware circuits that implement SHA256 computation. There are already many types of such hardware circuits in the prior art, and they will not be described in detail in this application. The 64 parallel long SHA256 computation circuits calculate 64 SHA256s as L0 leaf nodes based on 64 input records. Starting from the 32 parallel short SHA256 computation circuits, the calculation results are combined pairwise, sequentially processed through 16-way parallel computation, 8-way parallel computation, 4-way parallel computation, 2-way parallel computation, and finally converge to a single-way computation to obtain the final calculation result.

As shown in FIG. 9, there are four steps processed in a pipelined manner: Read Data until a complete binary tree with 64 leaf nodes is filled; Calculate the 64 parallel long SHA256s for the L0 level of this 64-leaf complete binary tree; Serial 32, 16, 8, 4, 2, 1 short SHA256 computations; Write this tree to SCM. In one processing unit, two 64-leaf complete binary trees are computed in parallel. Finally, L7˜Lroot are supplementarily calculated from the roots of these 64-leaf complete binary trees, and L7˜Lroot are subjected to Lazy Commit. The horizontal axis in the figure is time, which is only schematic and does not accurately represent the actual duration of each step.

Taking 1 million records as an example, a total of 14 levels from L7 to L24 need to be calculated. At its widest, it requires 214=16K short SHA256s computations.

Through the above design, the present application essentially shifts the bottleneck of the database's TPS from storage bandwidth to the bandwidth of the SHA256 PEs (Processing Units).

Below is an analysis of the performance bottleneck during database read transactions: parallel reading of ProofSets for multiple leaves.

System parameter settings: Database capacity is 1 billion transactions; single transaction data payload is 1 KB; total data payload space is 1 TB; total hash tree space is 64 GB; parallel read scale is 128 leaf nodes.

### Storage Hierarchy Design

1. SCM storage (approx. 63.5 GB):
   Each 4 KB page stores one 64-node full tree from L0 to L6;
   Page structure:
(L0-1, . . . , L0-64,
L1-1, . . . , L1-32,
L2-1, . . . , L2-16,
L3-1, . . . , L3-8,
L4-1, . . . , L4-4,
L5-1,L5-2,
L6-1)
   The SCM page structure is a duplicate of that in DDR, supporting direct data migration;
   The conversion from level number and intra-level serial number to in-page address uses a fixed formula, supporting hardware implementation.
2. DDR storage (512 MB): Stores nodes at L7 and higher levels.

Parallel read optimization: Reading, in parallel, the ProofSets for 128 randomly distributed leaves is equivalent to reading 128 64-node full trees from 128 4 KB pages at random addresses; then extracting the 7 corresponding elements from L0 to L6 from each full tree. Because this is a completely random 32-byte read, the read amplification is actually reduced from 128× to 128/7×.

During writing, the situation where the rightmost 64-leaf complete binary tree is incomplete must be handled (in memory, ensuring it is flushed to SCM before power loss).

Special case handling: During writing, the situation where the rightmost 64-node full tree is incomplete must be handled. The incomplete tree is kept in DDR, and it must be ensured that it is written into SCM before DDR loses power.

Performance optimization key points: Utilizes NAND page size characteristics; fully leverages data locality; implements address translation calculations in hardware, thereby increasing speed; minimizes random read overhead.

This design significantly reduces the read amplification effect and improves the overall read performance of the system through an optimized storage structure and parallel read strategy.

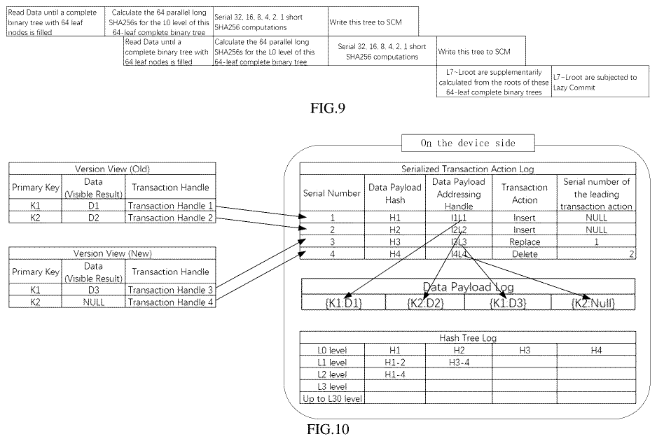

In one embodiment, a system for a verifiable key-value database comprises: a visible layer in the host machine's main memory, a middle layer on the device side, and an innermost layer. The overall design of this database is shown in FIG. 10.

In the visible layer of the host machine's main memory, multiple visible windows are set up. Each window presents a mapping relationship from a primary key to a data payload externally, and is implemented internally as a mapping relationship from a primary key to a transaction handle. Each window corresponds to a snapshot of a specific version of the database. The visible layer utilizes the computation and storage resources of the host machine, provides flexible multi-primary key construction and query functions, and can be reconstructed from the middle layer and the innermost layer. To optimize performance, the visible layer supports multi-level caching strategies, including a secure mode with no cache, a level-1 acceleration mode that caches data payload addressing handles after they have been confusion-hashed, and a level-2 acceleration mode that directly caches data payloads.

The middle layer on the device side implements serialized transaction log management, assigning a unique serial number and an external handle to each transaction. The log records the serial number, data payload index, data payload hash value, and related signature information. The middle layer adopts an improved journaled hash tree structure, the design of which is based on a transaction serialization mechanism. The transaction handle's security is enhanced through a device-specific confusion hash, which remains unchanged throughout the device's lifecycle.

The innermost layer on the device side maintains the data payload log, implementing a one-to-one correspondence between transaction actions and payload units. Each payload unit contains a complete key-value pair or data record. The middle layer uses SCM storage media, while the data payload log uses QLC storage media to balance performance and cost. The system supports the parallel use of storage bandwidth, allowing data payloads and hash proofs to be obtained simultaneously, and simplifies the design structure through a strict sequential-write, random-read mode. Although the transaction action log must be accessed before the data payload, storing the middle layer in SCM can effectively mitigate the performance loss.

The system constructs a version chain through leading transaction serial numbers, supports data version control, facilitates external audits, and reserves extension space to support future business needs. The host machine's CPU is responsible for performing operations such as primary key searches and transaction type judgments. This layered architecture balances performance and security through multi-level caching and optimized storage strategies, while ensuring data verifiability.

In summary, embodiments of the present application provide a verifiable key-value database system for data centers, used to support secure hosting services for multi-party data cooperation. This system provides real-time verifiability guarantees for data hosting through trusted computing circuits built into the disk or array, ensuring the confidentiality, consistency, integrity, and non-repudiation of the data. The system can provide real-time proof to customers, verifying that the hosted data has not been corrupted by the hosting party or a malicious third party. At the same time, the system can prove that the full database obtained after the customer's payment is identical to the database that was “cherry-picked” before payment.

The technical advantages of the embodiments of the present application lie in: significantly reducing system cost by optimizing storage and memory bandwidth utilization, as well as the parallel computation of SHA256. Compared to systems with equivalent performance that use server-based trusted computing solutions, the embodiments of the present application have a clear cost advantage. The field of data cooperation and transaction matchmaking is currently in the exploratory stage regarding legal permissions and value assessment. Large internet companies and authorized innovative enterprises are exploring verifiable database products based on data centers. As products based on server trusted computing solutions gradually form a competitive landscape in performance and price, the system described in the embodiments of the present application will have broad market application prospects.

Accordingly, embodiments of the present application also provide a computer-readable storage medium, on which computer-executable instructions are stored. The computer-executable instructions, when executed by a processor, implement the various method embodiments of the present application. The computer-readable storage media include permanent and non-permanent, removable and non-removable media implemented by any method or technology for storage of information. Information can be computer-readable instructions, data structures, program modules, or other data. Examples of the computer-readable storage media include, but are not limited to, Phase-Change Random Access Memory (PRAM), Static Random Access Memory (SRAM), Dynamic Random Access Memory (DRAM), other types of Random Access Memory (RAM), Read-Only Memory (ROM), Electrically Erasable Programmable Read-Only Memory (EEPROM), flash memory or other memory technologies, Compact Disc Read-Only Memory (CD-ROM), Digital Versatile Disc (DVD) or other optical storage, magnetic cassettes, magnetic disk storage or other magnetic storage devices, or any other non-transitory medium that can be used to store information accessible by a computing device. As defined herein, computer-readable storage media do not include transitory media, such as modulated data signals and carriers.

Furthermore, embodiments of the present application also provide a data read-write system for a key-value database, which comprises a memory for storing computer-executable instructions, and a processor; the processor is used to implement the steps in the above method embodiments when executing the computer-executable instructions in the memory. wherein the processor may be a Central Processing Unit (“CPU”), a Graphics Processing Unit (“GPU”), a Digital Signal Processor (“DSP”), a Microcontroller Unit (“MCU”), a Neural Processing Unit (“NPU”), an Application Specific Integrated Circuit (“ASIC”), a Field Programmable Gate Array (“FPGA”), or other programmable logic devices, etc. The aforementioned memory may be Read-Only Memory (ROM), Random Access Memory (RAM), flash memory, hard disk, or solid-state disk, etc. The steps of the methods disclosed in the various embodiments of the present application may be directly embodied as being executed by a hardware processor, or executed by a combination of hardware and software modules in the processor.

Furthermore, an embodiment of the present application also provides a computer program product, which includes computer-executable instructions that, when executed by a processor, perform the steps in the various method embodiments described above.

It should be noted that, in this application, relational terms such as “first”, “second”, etc. are used solely to distinguish one entity or operation from another without necessarily requiring or implying any actual relationship or order between the entities or operations. Moreover, the term “comprise”, “include”, or any other variants thereof are intended to cover a non-exclusive inclusion, such that a process, method, article, or apparatus that comprises a list of elements not only comprises those elements, but may also comprise other elements not expressly listed or inherent to such a process, method, article, or apparatus. Without further limitations, an element defined by the statement “comprising a” does not exclude the presence of additional identical elements in the process, method, article, or apparatus that comprises the element. In this application, if it is mentioned that an action is performed based on a certain element, it means performing that action based on at least that element, which includes two situations: (1) the behavior is performed only according to that element, and (2) the behavior is performed according to that element and other elements. The expressions ‘multiple’ and ‘a plurality of’ are defined to mean two or more than two.

The use of ordinal numbers in describing the method steps does not itself limit the order in which these steps may be performed. For example, steps with higher ordinal numbers do not necessarily need to be executed after those with lower numbers. They may be executed before, in parallel, or in any order that is reasonable to a person skilled in the art.

The specification includes combinations of the various embodiments described herein. Separate references to embodiments (e. g. “an embodiment” or “some embodiments” or “preferred embodiments”) do not necessarily refer to the same embodiment; however, these embodiments are not mutually exclusive unless indicated as such or as will be apparent to those skilled in the art. It should be noted that the word “or” is used in this specification in a non-exclusive sense unless the context expressly indicates or requires otherwise.

All documents mentioned in this specification are deemed as included in the disclosure of this application in their entirety so that they may serve as a basis for amendment if necessary. In addition, it shall be understood that the foregoing are merely preferred embodiments of the specification and are not intended to limit the scope of protection of the patent. Any modification, equivalent replacement, improvement, etc. within the spirit and principles of one or more embodiments of this specification shall be included in the scope of protection of such one or more embodiments of this specification.

In some cases, the actions or steps described in the claims may be executed in an order different from that shown in the embodiments and still achieve the desired results. Additionally, the processes depicted in the drawings do not necessarily require the specific order or sequential order shown to achieve the desired results. In certain embodiments, multi-tasking and parallel processing may also be possible or advantageous.

What is claimed is:

1. A method for a key-value database that improves database write performance by reducing hash computation overhead, the method comprising:
receiving, by a processor, a write request, the write request comprising key-value pair data;
writing, by the processor, the key-value pair data as a data payload to a first memory;
calculating, by the processor, a hash value of the data payload and writing the hash value to a binary hash tree stored in a fourth memory as a highest leaf node with a current largest serial number;
wherein in the binary hash tree, serial numbers of respective leaf nodes increase in sequence, leaf nodes with serial numbers not greater than that of the highest leaf node are concrete nodes with values being hash values of corresponding data payloads, and leaf nodes with serial numbers greater than that of the highest leaf node are virtual nodes with values being a preset value, the preset values being used to be distinguished from normal hash values;
determining, by the processor, in a direction from leaf nodes to a root node, whether respective parent nodes corresponding to the highest leaf node are located within a complete concrete subtree, wherein the complete concrete subtree is a subtree that does not contain any virtual nodes;
in response to determining that the parent node is located within the complete concrete subtree, treating the parent node as a concrete node, calculating a hash value of the parent node based on hash values of two child nodes of the parent node, and storing the hash value of the parent node into the fourth memory; and
in response to determining that the parent node is not located within the complete concrete subtree, treating the parent node as a virtual node, and when needing to obtain a hash value of the parent node, directly using a value of its child node whose value is not the preset value as the hash value of the parent node.

2. The method according to claim 1, further comprising:
forming multiple complete concrete subtrees from left to right in the binary hash tree, and the processor adds root nodes of the respective complete concrete subtrees to a root set;
obtaining, by the processor, a global root hash value by calculating hash values of the nodes in the root set level by level from right to left;
generating, by the processor, a proof set for the highest leaf node, wherein elements in the proof set are hash values of paired nodes at each level on a path from the highest leaf node to a proof target node in the binary hash tree; the proof target node is a root node of a smallest complete concrete subtree containing the highest leaf node, and the proof target node is an element in the root set; and
returning, by the processor, data for verifying the write operation to a requesting party device, the data comprising: the global root hash value, the root set, and the proof set.

3. The method according to claim 2, wherein the data returned by the processor to the requesting party device is configured to enable the requesting party device to verify the correctness of the write in the following manner: a proof target node is calculated based on the proof set and the hash value of the leaf node, the proof target node is an element in the root set; and, it is possible to obtain the global root hash value by calculating the hash values of the respective elements in the root set level by level.

4. The method according to claim 1, wherein the fourth memory comprises a second memory and a third memory; the first memory and the second memory are non-volatile memories; the access bandwidth of the second memory is higher than that of the first memory, and the access bandwidth of the third memory is higher than that of the second memory; and
nodes from level 0 to level N of the binary hash tree are stored in the second memory, wherein the nodes from level 0 to level N are organized into at least one complete subtree, and each said complete subtree is stored in one page of the second memory, with a storage space size of the complete subtree being the same as a size of the page; nodes at level N+1 and higher levels of the binary hash tree are stored in the third memory; wherein N is a preset positive integer.

5. The method according to claim 4, wherein, in each page of the second memory, nodes of each level of a complete subtree are stored level by level, from level 0 to level N; a serial number of the leaf node is directly used as its storage position at level 0; a one-to-one correspondence between node serial numbers and storage positions is maintained at each level; and
the processor comprises multiple parallel long SHA256 computation circuits and multiple parallel short SHA256 computation circuits, wherein the long SHA256 computation circuits are used to calculate, in parallel, hash values of respective leaf nodes in a page based on the data payloads, and the short SHA256 computation circuits are used to perform paired calculations on adjacent pairs of leaf nodes to obtain parent nodes at level 1, and then, through multi-way parallel computation level by level from bottom to top, finally converge to a single-way computation to obtain a root hash value of the complete subtree.

6. The method according to claim 5, further comprising:
for a complete subtree where a number of concrete leaf nodes is less than or equal to half of a maximum number of leaf nodes, calculating a virtual root hash value for the complete subtree using virtual nodes; and
for a complete subtree where a number of concrete leaf nodes is greater than half of a maximum number of leaf nodes and less than or equal to the maximum number of leaf nodes, after being filled to become a full tree, discarding previously-used virtual nodes, and recalculating hash values for the entire complete subtree up to the root; wherein the maximum number of leaf nodes is a total number of leaf nodes of the complete subtree when it is in a full state.

7. The method according to claim 5, wherein, when batch writing key-value pair data, the following four-stage pipeline approach is used for processing, wherein the respective stages can be executed in parallel:
in a first pipeline stage, reading 64 key-value pair data items to form one complete subtree;
in a second pipeline stage, using 64 parallel SHA256 computation circuits to calculate hash values of the 64 key-value pair data items as leaf nodes;
in a third pipeline stage, using 32 parallel SHA256 computation circuits to perform paired calculations on adjacent pairs of leaf nodes in a page, proceeding sequentially through 16-way parallel computation, 8-way parallel computation, 4-way parallel computation, 2-way parallel computation, and single-way computation, to obtain hash values of nodes at each level of the complete subtree; and
in a fourth pipeline stage, writing the node hash values of the complete subtree into one 4 KB page of the second memory.

8. A method for a key-value database that reduces verification data volume and improves verification efficiency by generating a minimal proof set, wherein key-value pair data is stored as data payloads with increasing serial numbers in a first memory, and a binary hash tree is stored in a fourth memory; wherein in the binary hash tree, each leaf position corresponds to a serial number, leaf nodes with serial numbers not greater than a maximum serial number of the data payloads in the first memory are concrete nodes with values being hash values of corresponding data payloads, and leaf nodes with larger serial numbers are virtual nodes with values being a preset value, the preset values being used to be distinguished from normal hash values; for a parent node, if either of its child nodes is a virtual node, the parent node is a virtual node, and its value is equal to the value of its child node whose value is not the preset value, otherwise, the parent node is a concrete node, and its value is a result of a hash operation on its two child nodes; the method comprising:
receiving, by the processor, a read request from a requesting party device, and reading a requested data payload from the first memory, wherein a leaf node corresponding to the data payload is a target leaf node;
generating, by the processor, a proof set for the target leaf node, wherein elements in the proof set are hash values of paired nodes at each level on a path from the target leaf node to a proof target node in the binary hash tree; the proof target node is a root node of a smallest complete concrete subtree containing the target leaf node; the complete concrete subtree is a subtree that does not contain any virtual nodes; and
returning, by the processor, the requested data payload and the proof set to the requesting party device.

9. The method according to claim 8, wherein the data returned by the processor to the requesting party device is configured to enable the requesting party device to verify the correctness of the read data in the following manner: obtaining a global root hash value and a root set, wherein the global root hash value is a hash value of a root node of the binary hash tree, and the root set comprises root nodes of multiple complete concrete subtrees from left to right in the binary hash tree; calculating a proof target node based on the proof set and a hash value of the target leaf node, the proof target node is an element in the root set; and being able to obtain the global root hash value by calculating the hash values of the respective elements in the root set level by level.

10. The method according to claim 8, wherein the processor determines the proof target node through steps of:
starting from a most significant bit of a serial number of a current highest leaf node of the binary hash tree, checking a corresponding complete concrete subtree;
when a serial number of the target leaf node is less than or equal to a number of leaf nodes in the current complete concrete subtree, then a root node of the current complete concrete subtree is taken as the proof target node; and
when the serial number of the target leaf node is greater than the number of leaf nodes in the current complete concrete subtree, then the number of leaf nodes of the current complete concrete subtree is subtracted from the serial number of the target leaf node, and the check continues to a complete concrete subtree corresponding to the next significant bit, until the complete concrete subtree containing the target leaf node is found.

11. The method according to claim 8, wherein the step of the processor generating the proof set comprises:
converting a serial number of the target leaf node to binary;
establishing a level mapping, with a least significant bit corresponding to level 0; and
processing level by level starting from the target leaf node: checking an index value of a current node to determine if it is a left node or a right node, if it is a left node, calculating a serial number of a corresponding right-side paired node and adding the hash value of the paired node to the proof set, if it is a right node, calculating a serial number of a corresponding left-side paired node and adding the hash value of the paired node to the proof set, until a level of the proof target node is reached.

12. The method according to claim 8, wherein the fourth memory comprises a second memory and a third memory; the first memory and the second memory are non-volatile memories; the access bandwidth of the second memory is higher than that of the first memory, and the access bandwidth of the third memory is higher than that of the second memory; and
nodes from level 0 to level N of the binary hash tree are stored in the second memory, wherein the nodes from level 0 to level N are organized into at least one complete subtree, and each said complete subtree is stored in one page of the second memory, with a storage space size of the complete subtree being the same as a size of the page; nodes at level N+1 and higher levels of the binary hash tree are stored in the third memory; wherein N is a preset positive integer.

13. The method according to claim 11, wherein the processor determines the path from the target leaf node to the proof target node using the following index-based hardware computation method:
convert a target leaf serial number to binary as an index for level 0; and
in the processing of each level: determine a node type by checking a least significant bit of the index, if the least significant bit is 1, it is a left node, if it is 0, it is a right node; for a left node, find a right-side paired node by adding 1; for a right node, find a left-side paired node by subtracting 1; obtain a corresponding index for a next higher level by a right shift operation of 1 bit on the index; repeat the above process until a level of the proof target node is reached.

14. The method according to claim 12, wherein the processor employs a hardware pipeline structure to parallelly process read requests for multiple leaf nodes, using the following approach for processing:
in a first pipeline stage, calculating in parallel indices at various levels for multiple target leaf nodes using bitwise operations;
in a second pipeline stage, reading, in parallel, nodes from level 0 to level 6 from multiple 4 KB pages in the second memory and extracting nodes belonging to the proof sets;
in a third pipeline stage, reading, in parallel, nodes belonging to the proof sets from level 7 to a root node, corresponding to the multiple target leaf nodes, from the third memory; and
in a fourth pipeline stage, using multiple parallel SHA256 computation circuits to calculate, in parallel, hash values of multiple verification paths and return complete proof sets.

15. The method according to claim 14, wherein the processor comprises:
hardware acceleration circuits for calculating SHA256 hash values, comprising:
multiple parallel long SHA256 computation circuits, configured to calculate hash values of data payloads; and
multiple parallel short SHA256 computation circuits, configured to calculate hash values of nodes on verification paths;
wherein the processor supports the simultaneous use of multiple SHA256 computation circuits in parallel during a verification process.

16. A non-transitory computer-readable storage medium, wherein the non-transitory computer-readable storage medium stores computer-executable instructions, and the computer-executable instructions, when executed by a processor, implement the steps in the method according to claim 1.

17. A non-transitory computer-readable storage medium, wherein the non-transitory computer-readable storage medium stores computer-executable instructions, and the computer-executable instructions, when executed by a processor, implement the steps in the method according to claim 8.
